(19) United States
(12) Patent Application Publication
(10) Pub. No.: US 2009/0050426 A1
(43) Pub. Date: Feb. 26, 2009

(54) Vibration Damper Comprising a Protection Against Stones

(75) Inventor: Gunther Handke, Euerbach (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/087,563

(22) PCT Filed: Dec. 16, 2006
(86) PCT No.: PCT/EP2006/012159

§ 371 Date: Jul. 8, 2008

(30) Foreign Application Priority Data
Jan. 9, 2006 (DE) 10 2006 011 305.0

(51) Int. Cl. F16F 9/38

(52) U.S. Cl. 188/322.12

(57) ABSTRACT

The invention relates to an vibration damper (1) comprising a cylinder (15) on which a protection against stones (3) is arranged in a fixed manner in the form of a tubular part (5). Said tubular part (5) is supported by means of holding tongues (11a;11b) on a connection element (13) in which the holding tongues (11a;11b) are actively connected to the tubular part (5) by means of at least one catch connection. Each holding tongue (11a;11b) represents a separate component and comprises catch means (7a;7b) which enter into the catch connection with the tubular part (5).

### TECHNICAL AREA

The invention pertains to a vibration damper with stone guard according to the introductory clause of claim 1.

### PRIOR ART

A vibration damper with stone guard is known from DE 10 2004 014 250 A1. The stone guard consists of a tubular part, which is mounted axially on the cylinder of the vibration damper. The bottom of the vibration damper has an area of increased diameter, on which the tubular part is axially supported.

From the vehicles “Ford Falcon UTE” and “Ford Falcon RTV”, a vibration damper with stone guard is known according to FIGS. 1 and 2. The plastic tubular part has, at one end, two axially oriented snap hooks, which enter into latching engagement with a ring-shaped bracket. On the ring-shaped bracket, two curved retaining tongues are provided, which at least partially surround a connecting eye at the bottom end of the vibration damper and thus fix the tubular part effectively in position in the axial and circumferential directions.

The disadvantage of the invention is that relatively complicated injection molds are required for both the tubular part and the ring-shaped bracket, because undercuts are present on both components, which make it difficult to remove the parts from the mold. In addition, a complicated injection mold must be fabricated separately for each width of the connecting eye. If, for example, the contour of the bottom of the vibration damper differs from a conventional design, it will again be necessary to fabricate a new injection mold.

### DESCRIPTION OF THE INVENTION

The task of the present invention is to improve guarding against stones in such a way that the problems known from the prior art involving adaptation to different types of vibration dampers are solved at lower cost.

According to the invention, this task is accomplished in that each retaining tongue represents a separate component and has latching means, which enter into latching engagement with the tubular part.

Because the retaining tongues are designed as individual parts, much simpler injection molds can be used to produce them. Variants for different vibration damper designs can be fabricated at lower cost.

According to an advantageous subclaim, the retaining tongues have at least one snap hook at one end, which engages in a receptacle in the tubular part.

In an another advantageous embodiment, the retaining tongue has a plurality of snap hooks, which are separated from each other by axially oriented slots. This considerably improves the reliability with which the retaining tongues are prevented from rotating on the tubular part.

The snap hooks are arranged on a reference circle at a certain angle to each other and therefore occupy a comparatively small amount of radial space.

To avoid undercuts on the tubular part, the receptacle in the tubular part is formed by a groove, which is bounded by a frame extending concentrically to the tubular part. This special from of the receptacle makes it extremely easy to remove the tubular part from the mold.

### SHORT DESCRIPTION OF THE DRAWINGS

The invention is to be explained in greater detail on the basis of following description of the figures:

FIG. 1 shows a vibration damper according to the prior art;

FIG. 2 shows a stone guard for the damper according to FIG. 1;

FIGS. 3 and 4 show a vibration damper with inventive stone guard;

FIG. 5 shows a stone guard for the damper according to FIGS. 3 and 4;

FIG. 6 shows the tubular part of the stone guard of FIG. 5; and

FIGS. 7-9 show retaining tongues of the stone guard of FIG. 5.

### VARIOUS REALIZATIONS OF THE INVENTION

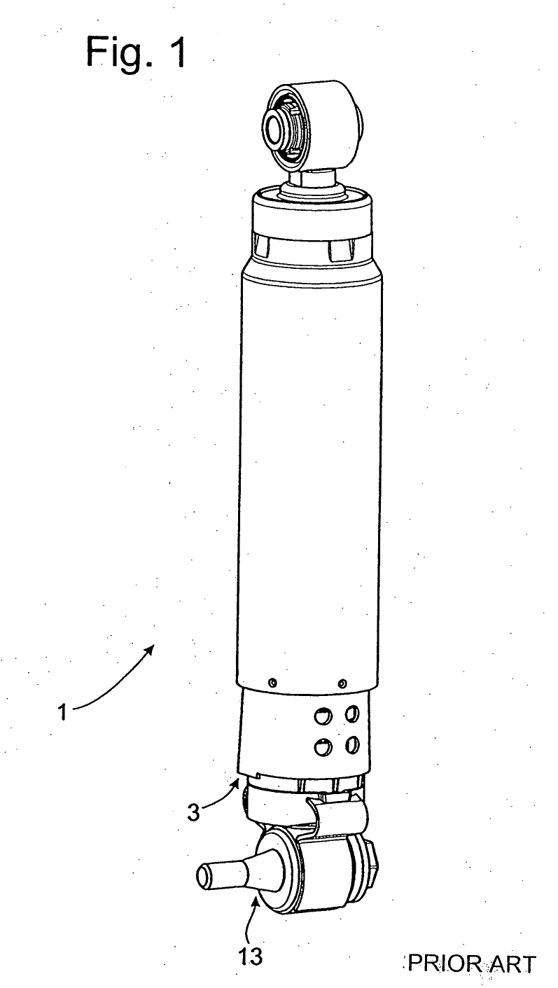

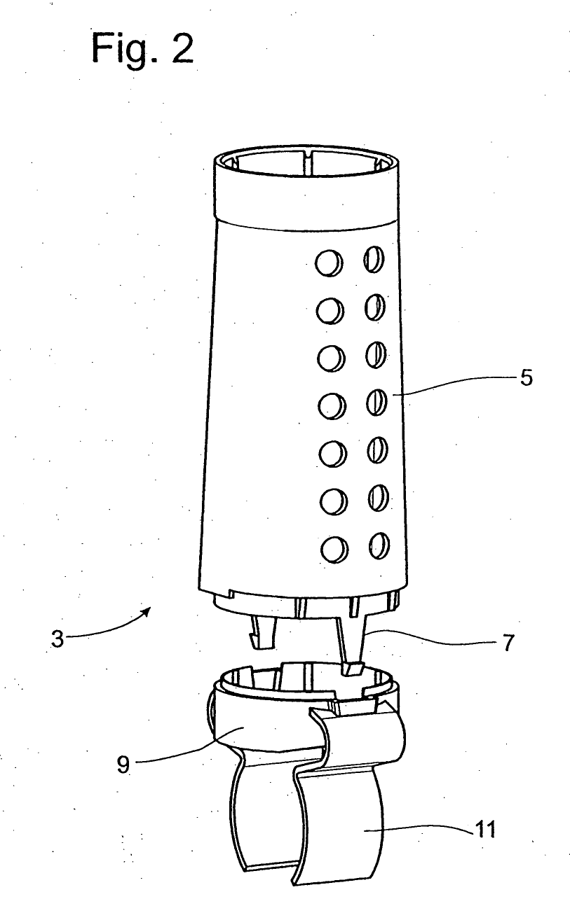

FIG. 1 shows a vibration damper 1 with a stone guard 3 according to FIG. 2, as known from the prior art. The stone guard 3 comprises a tubular part 5, which has snap hooks 7a, 7b at one end. On a ring-shaped bracket 9, two retaining tongues are provided opposite the hooks; these tongues at least partially surround a connecting eye 13 and thus carry the entire stone guard. The retaining tongues of the ring-shaped bracket also protect the connecting eye from impacts by stones.

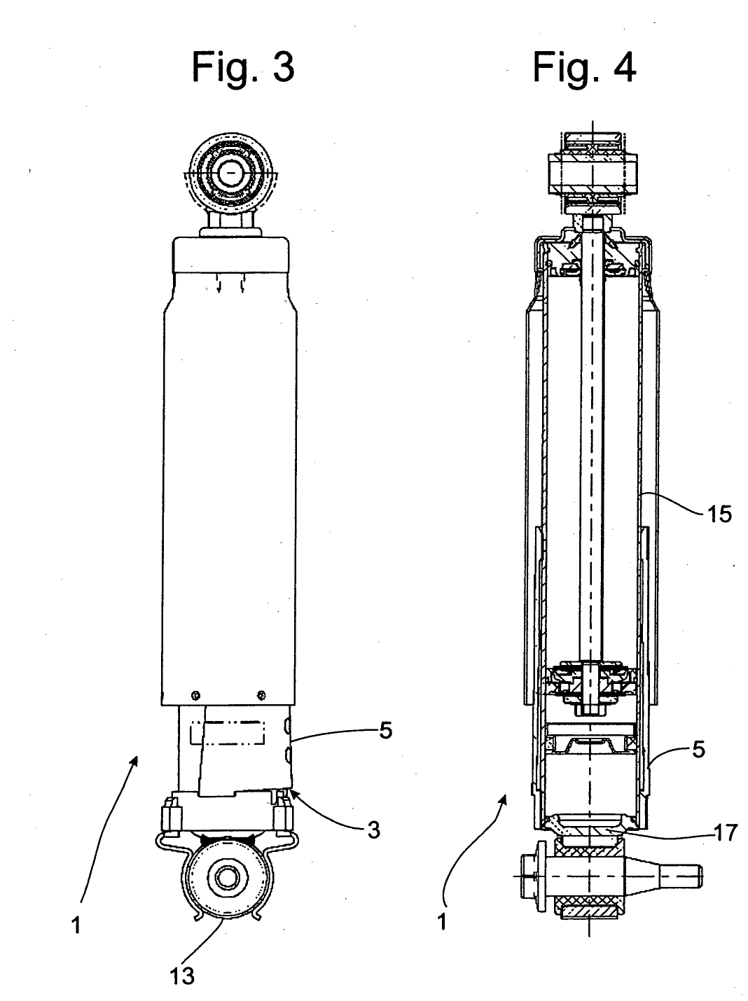

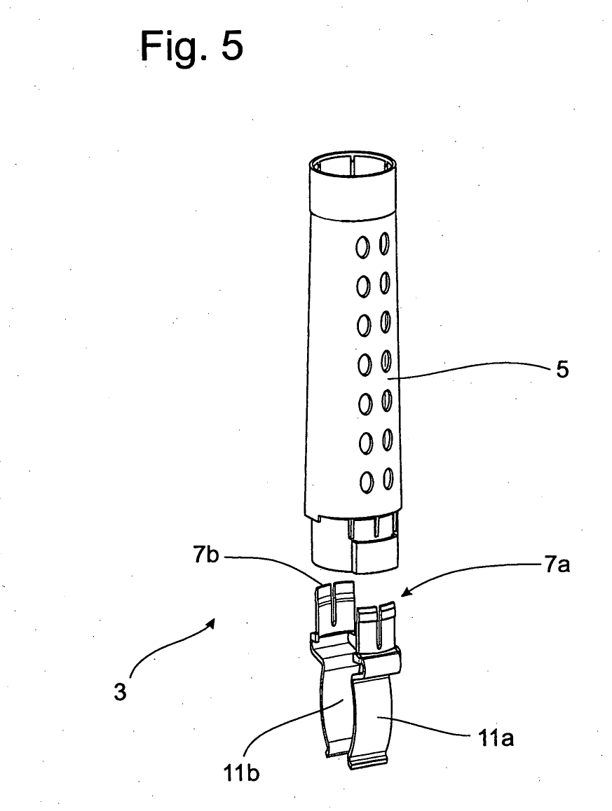

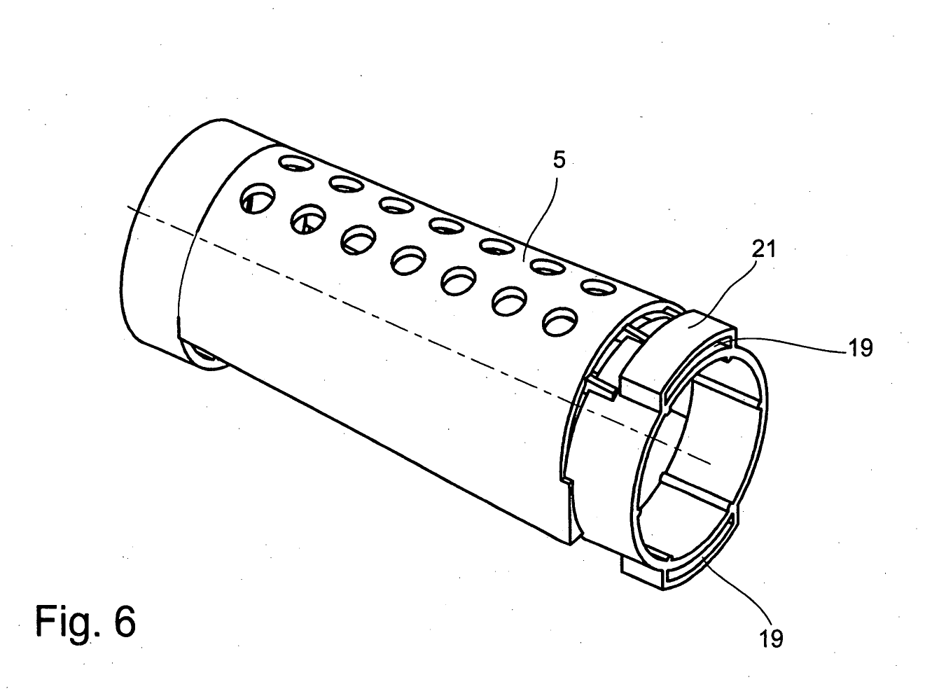

FIGS. 3 and 4 show an inventive stone guard, which, as shown in FIG. 5, also has a tubular part 5, which proceeds from the bottom 17 and covers the cylinder 15 of the vibration damper 1. As can be seen in FIG. 6, the tubular part 5 has two receptacles 19 at the end pointing toward the bottom. These receptacles are designed in the form of grooves and, each one is bounded by a frame 21, which is concentric to the tubular part. The tubular part preferably consists of plastic and is produced by injection molding.

It can also be seen from FIG. 5 that two retaining tongues 11a, 11b are in the form of separate components, which engage with the tubular part 5 by way of snap hooks 7a, 7b and thus latch to it, where the snap hooks 7a, 7b engage in the receptacles 19 of the tubular part 5.

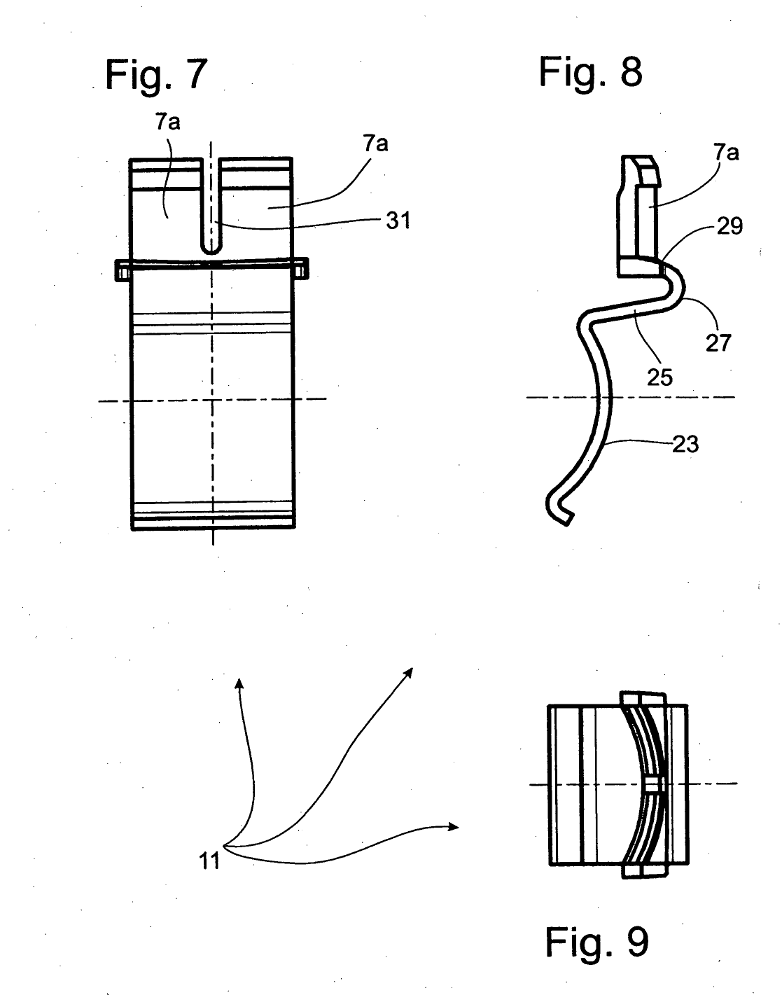

FIGS. 7-9 show retaining tongues 11a, 11b as isolated parts. The retaining tongue has a curved support section 23, which rests on the outside surface of the connecting eye 13 (FIG. 3). A radially oriented section 25 with a transition arc 27 leading to a radial support surface 29 proceeds from the curved support section. From the radial surface, two snap hooks 7a extend in the longitudinal direction of the tubular part. The hooks are separated from each other by an axial slot 31. It is especially clear from FIG. 9 that the snap hooks are arranged on a reference circle at a certain angle to each other. The retaining tongue, as FIG. 8 shows, can be very easily produced by injection-molding, because the parting line can be perpendicular to the plane of FIG. 8, corresponding, for example, to the internal contour, and thus there will be no undercuts present.

FIG. 5 shows how the retaining tongues 11a, 11b are installed. The stone guard 3, independently of the vibration damper, is mounted in a jig, and the retaining tongues 11a, 11b are brought up from underneath toward the tubular part 5 until the snap hooks 7a, 7b pass through the groove 19 and the tubular part 5 has come to rest on the support surface 29 of the retaining tongues 11a, 11b. The entire stone guard 3 is then pushed over the end of the cylinder 15, i.e., the end at which the piston rod emerges to the outside, until the curved support sections 23 surround the connecting eye 13.

1-5. (canceled)

6. Vibration damper with a cylinder, comprising:
a stone guard comprising a tubular part immovably mounted on the vibration damper, and
retaining tongues which support the tubular part on a connecting element;
wherein in that the retaining tongues are in working connection with the tubular part by a latching engagement, and
wherein each retaining tongue being a separate component and having latching means which enter into latching engagement with the tubular part.

7. The vibration damper according to claim 6, wherein the retaining tongues each include at least one snap hook at one end which fixedly engages into a receptacle in the tubular part.

8. The vibration damper according to claim 7, wherein each retaining tongue has a plurality of snap hooks which are separated from each other by axially oriented slots.

9. The vibration damper according to claim 8, wherein each of said plural snap hooks are arranged on a reference circle at a specific angle to each other.

10. The vibration damper according to claim 6, wherein the receptacle in the tubular part is formed by a groove, which is bounded by a frame concentric to the tubular part.
